(19) United States
(12) Patent Application Publication
(10) Pub. No.: US 2024/0221166 A1
(43) Pub. Date: Jul. 4, 2024

(54) POINT-LEVEL SUPERVISION FOR VIDEO INSTANCE SEGMENTATION

(71) Applicant: NVIDIA Corporation, Santa Clara, CA (US)

(72) Inventors: Zhiding Yu, Cupertino, CA (US); Shuaiyi Huang, Greenbelt, MD (US); De-An Huang, Cupertino, CA (US); Shiyi Lan, Sunnyvale, CA (US); Subhashree Radhakrishnan, Milpitas, CA (US); Jose M. Alvarez Lopez, Mountain View, CA (US); Anima Anandkumar, Pasadena, CA (US)

(21) Appl. No.: 18/395,198

(22) Filed: Dec. 22, 2023

Related U.S. Application Data
(60) Provisional application No. 63/437,060, filed on Jan. 4, 2023.

(51) Int. Cl. G06T 7/12; G06V 10/764; G06V 20/70

(52) U.S. Cl. CPC G06T 7/12; G06V 10/764; G06V 20/70; G06T 2207/20081

(57) ABSTRACT

Video instance segmentation is a computer vision task that aims to detect, segment, and track objects continuously in videos. It can be used in numerous real-world applications, such as video editing, three-dimensional (3D) reconstruction, 3D navigation (e.g. for autonomous driving and/or robotics), and view point estimation. However, current machine learning-based processes employed for video instance segmentation are lacking, particularly because the densely annotated videos needed for supervised training of high-quality models are not readily available and are not easily generated. To address the issues in the prior art, the present disclosure provides point-level supervision for video instance segmentation in a manner that allows the resulting machine learning model to handle any object category.

### RELATED APPLICATION(S)

This application claims the benefit of U.S. Provisional Application No. 63/437,060 (Attorney Docket No. NVIDP1371+/22-SC-1520US01), titled “POINT-SUPERVISED VIDEO INSTANCE SEGMENTATION” and filed Jan. 4, 2023, the entire contents of which is incorporated herein by reference.

### TECHNICAL FIELD

The present disclosure relates to the video instance segmentation.

### BACKGROUND

Video instance segmentation is a computer vision task that aims to detect, segment, and track objects continuously in videos. It can be used in numerous real-world applications, such as video editing, three-dimensional (3D) reconstruction, 3D navigation (e.g. for autonomous driving and/or robotics), and view point estimation. To achieve accurate results efficiently, artificial intelligence methods have been used for video instance segmentation.

Ideally, a machine learning model would be trained in a supervised manner to be able to perform video instance segmentation. However, this training task requires that training videos be densely annotated per-frame (i.e. with object labels). Since annotating videos in this manner is extremely time consuming, the availability of such training videos is currently limited which inhibits the ability to train a high quality machine learning model with supervised learning that solely uses training videos.

To address the lack of training videos, some techniques have been developed to train a machine learning model with reduced annotations, such as by using image level annotations which are readily available in the public domain. However, these techniques still require either dense annotations in subsampled video frames, do not provide competitive results compared with supervised approaches, and/or can only handle the object categories that are overlapping between the video and image training datasets.

There is a need for addressing these issues and/or other issues associated with the prior art. For example, there is a need to provide point-level supervision for video instance segmentation, which can reduce model training costs while improving performance of the model.

### SUMMARY

A method, computer readable medium, and system are disclosed for point-level supervision for video instance segmentation. A point-level annotation defined for at least one object in a video is determined. The point-level annotation for the at least one object is used to train a machine learning model with point-level supervision to perform video instance segmentation.

### BRIEF DESCRIPTION OF THE DRAWINGS

FIG. 1 illustrates a flowchart of a method for point-level supervision for video instance segmentation, in accordance with an embodiment.

FIG. 2 illustrates a block diagram of the fine-tuning of a pre-trained machine learning model to perform video instance segmentation, in accordance with an embodiment.

FIG. 3 illustrates a flowchart of a method for fine-tuning of the pre-trained machine learning model of FIG. 2 to perform video instance segmentation, in accordance with an embodiment.

FIG. 4 illustrates a block diagram of a data flow for providing point-level supervision for video instance segmentation, in accordance with an embodiment.

FIG. 5 illustrates an example of pseudo masks predicted for objects in a video, in accordance with an embodiment.

FIG. 6 illustrates a flowchart of a method for video instance segmentation, in accordance with an embodiment.

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 illustrates an example data center system, according to at least one embodiment.

### DETAILED DESCRIPTION

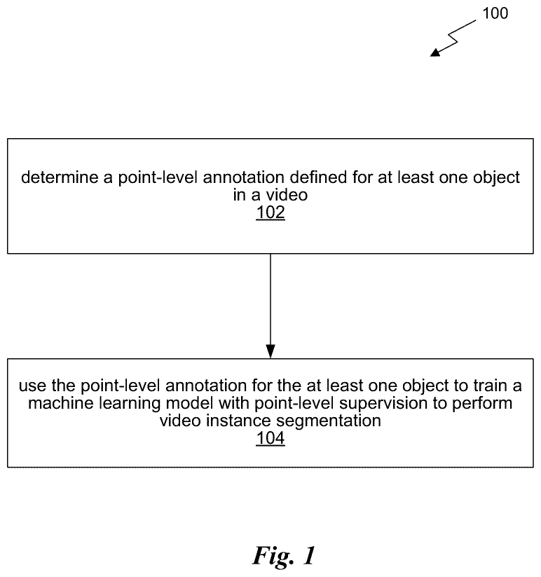

FIG. 1 illustrates a flowchart of a method 100 for point-level supervision for video instance segmentation, in accordance with an embodiment. The method 100 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device may cause the device to perform the method 100.

In operation 102, a point-level annotation defined for at least one object in a video is determined. The video includes a sequence of frames depicting one or more objects. Motion of at least one of the objects may be depicted across at least a portion of the frames in the video. The object refers to any category of material item capable of being depicted in a frame of a video, such as a person, an animal, a vehicle, etc. It should be noted that while “an object” or “the object” may be referred to in the description below, the operation 102 equally applies to embodiments where annotations are defined for multiple objects in the video.

The point-level annotation refers to an annotation (e.g. label) that is correlated to a particular point (e.g. pixel) on the object in at least one frame of the video. The annotation may include various information that describes, defines, etc. the object. In an embodiment, the point-level annotation may indicate a classification of the object. In another embodiment, the point-level annotation may further indicate a location (e.g. coordinates) of the object in the frame of the video. In yet another embodiment, the point-level annotation may further indicate whether the object is in a foreground or a background of the video.

In an embodiment, the point-level annotation may be defined for an object over a plurality of frames of the video. For example, an annotation for the object may be provided for each of multiple frames of the video. The frames may be a sampled subset of all frames in the video. In another possible embodiment, the point-level annotation may be defined for the object in only a single frame of the entire video.

Determining the point-level annotation for an object may refer to receiving (e.g. from a user), identifying (e.g. from a file), accessing (e.g. in memory), etc. the point-level annotation. In an embodiment, the point-level annotation may be input by a user. In an embodiment, the point-level annotation may be input by the user during playback of the video. For example, a user may select the point on the object in one of the frames of the video, and may input the annotation for the selected point. In an embodiment, an annotation tool may be used by the user to input the point-level annotation for the object.

In operation 104, the point-level annotation for the at least one object is used to train a machine learning model with point-level supervision to perform video instance segmentation. The machine learning model refers to a model that is capable of being trained, using machine learning, to perform a certain task. In the present description, the machine learning model is trained on the point-level annotation given for one or more objects in the video. As mentioned, the machine learning model is trained to be able to perform video instance segmentation. Video instance segmentation refers to a computer task in which at least one object in a video is detected, segmented, and tracked across one or more frames of the video.

In an embodiment, the machine learning model may be pre-trained on a data set of images having mask annotations for objects in the images. In other words, prior to operation 104, the machine learning model may be trained to perform image instance segmentation using the data set of images. The images refer to independent images, and while the images may be include in a sequence, the images are not the same as frames of a video. A mask annotation given for an image refers to one or more annotations that each define an object in the image. The data set of images may be a publicly available data set, in an embodiment.

As also mentioned, the machine learning model is trained with point-level supervision. Point-level supervision can be differentiated from frame-level supervision or even full video supervision, in the present description. Point-level supervision refers to using the point-level annotation as a ground truth for the object in the video, such that the machine learning model is trained to detect, segment, and track the object identified by the point-level annotation. The learning may be conditioned on a loss function which provides the basis for adjusting the model until an error computed through the loss function is minimized to a defined level.

In an embodiment, using the point-level annotation to train the machine learning model may include densifying the point-level annotation for training the machine learning model to perform video instance segmentation. In another embodiment, using the point-level annotation to train the machine learning model may include using the point-level annotation for an object as a negative cue for other objects in the video.

In an embodiment, training the machine learning model with point-level supervision may include processing the video by the pre-trained machine learning model to predict masks for one or more objects in the video (e.g. each of which be of a new category for which the machine learning model is not pre-trained). The mask may refer to an indicator that defines an object in the video, such as a location of the object, a classification of the object, etc. Training the machine learning model with point-level supervision may further include fine-tuning the pre-trained machine learning model based on the point-level annotation defined for the at least one object in the video and based on the masks predicted for the one or more objects in the video. In an embodiment, the pre-trained machine learning model may further output a confidence score for each of the masks predicted for the one or more objects in the video.

In an embodiment, fine-tuning the pre-trained machine learning model, as described above, for each object having a point-level annotation may include selecting one of the masks predicted for the object as a final pseudo mask for the object, and further training the machine learning model with the selected mask predicted for the object, using a loss for mask prediction and a cross-entropy loss for classification. In an embodiment, the loss for mask prediction may include a cross-entropy and dice loss.

The one of the masks predicted for the object may be selected for use in training the model based upon a defined criteria. In an embodiment, one of the masks predicted for the object may be selected by using the point-level annotation defined for the object as a negative cue for other objects in the video to filter out masks predicted for the other objects in the video. In an embodiment, one of the masks predicted for the object may be selected based on a matching cost computed for each of the masks predicted for the object. For example, the matching cost may be computed for each of the masks predicted for the object based on an annotated cost which penalizes masks predicted for the object that do not overlap with the point-level annotation defined for the object. As another example, the matching cost may be computed for each of the masks predicted for the object based on a cross-instance negative cost that penalizes masks predicted for the object that overlap with a point-level annotation defined for another object in the video. As still yet another example, the matching cost may be computed for each of the masks predicted for the object based on a confidence cost that is a negative of a confidence score of the masks predicted for the object. Of course, the matching cost may be computed based on upon a plurality of criteria as well, such as an annotated cost which penalizes masks predicted for the object that do not overlap with the point-level annotation defined for the object, a cross-instance negative cost that penalizes masks predicted for the object that overlap with a point-level annotation defined for another object in the video, and a confidence cost that is a negative of a confidence score of the masks predicted for the object.

In an embodiment, training the machine learning model with point-level supervision may further include processing the video using the fine-tuned machine learning model to predict new masks for one or more objects in the video, and additionally performing additional fine-tuning of the fine-tuned machine learning model based on the new masks predicted for the one or more objects in the video. In an embodiment, confidence scores may be output by the fine-tuned machine learning model for the new masks predicted for the one or more objects in the video. In this embodiment, the additional fine-tuning may be performed based on the confidence scores.

To this end, the method 100 provides point-level supervision for video instance segmentation. By using point-level supervision, for example as opposed to frame-level supervision which requires fully annotating at least a subset of frames of a video, the cost of generating training data required for training the machine learning model may be reduced. Furthermore, an embodiment in which the model is pre-trained on an image data set, as described above, may allow for improved performance of the machine learning model when further trained on the point-level annotation(s) given in the video, and may also allow the model to handle object categories that may not necessarily be covered by the video annotation(s).

Further embodiments will now be provided in the description of the subsequent figures. It should be noted that the embodiments disclosed herein with reference to the method 100 of FIG. 1 may apply to and/or be used in combination with any of the embodiments of the remaining figures below.

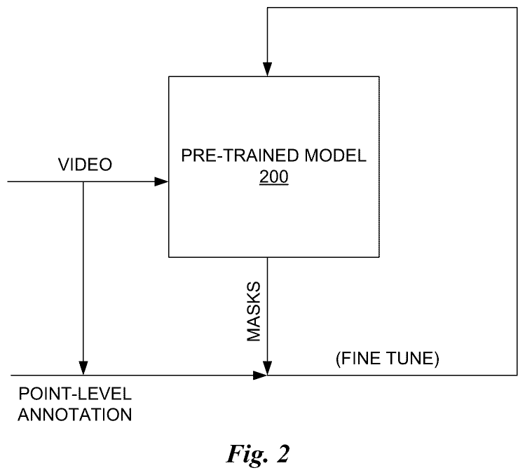

FIG. 2 illustrates a block diagram of the fine-tuning of a pre-trained machine learning model 200 to perform video instance segmentation, in accordance with an embodiment. In the present embodiment, the pre-trained machine learning model 200 refers to a model that has been trained to detect objects in images. In the present embodiment, the pre-trained machine learning model 200 may have been trained for object detection using annotated images.

As shown, a video is input to the pre-trained machine learning model 200 for processing. The video includes at least one frame having at least one point-level annotation for an object in the frame. It should be noted that while the present description refers to “an object,” the process described herein may equally apply when point-level annotations are given for multiple objects in the video.

The pre-trained machine learning model 200 processes the video to provide video instance segmentation (i.e. detection, segmentation, and tracking of the object in the video). The output of the pre-trained machine learning model 200 is at least one mask prediction for the object. Based upon the mask prediction(s) and the point-level annotation, the pre-trained machine learning model 200 is fine-tuned (e.g. optimized, the weights and/or parameters adjusted, etc.).

In an embodiment, one of the masks predicted for the object may be selected (e.g. as a final pseudo mask for the object). In various embodiments, the mask may be selected by using the point-level annotation defined for the object as a negative cue for other objects in the video to filter out masks predicted for the other objects in the video and/or based on a matching cost computed for each of the masks predicted for the object. The machine learning model may then be fine-tuned by training the model using a loss between the point-level annotation and the selected mask. For example, the loss may be for mask prediction and a cross-entropy loss for classification.

An additional fine-tuning iteration may also be performed, in an embodiment. For example, the video may be processed again using the fine-tuned machine learning model to predict at least one new masks for the object in the video. The fine-tuned machine learning model may then be further fine-tuned based upon the new mask prediction(s) and the point-level annotation given for the object. This fine-tuning process may be repeated until a defined stopping criteria is met.

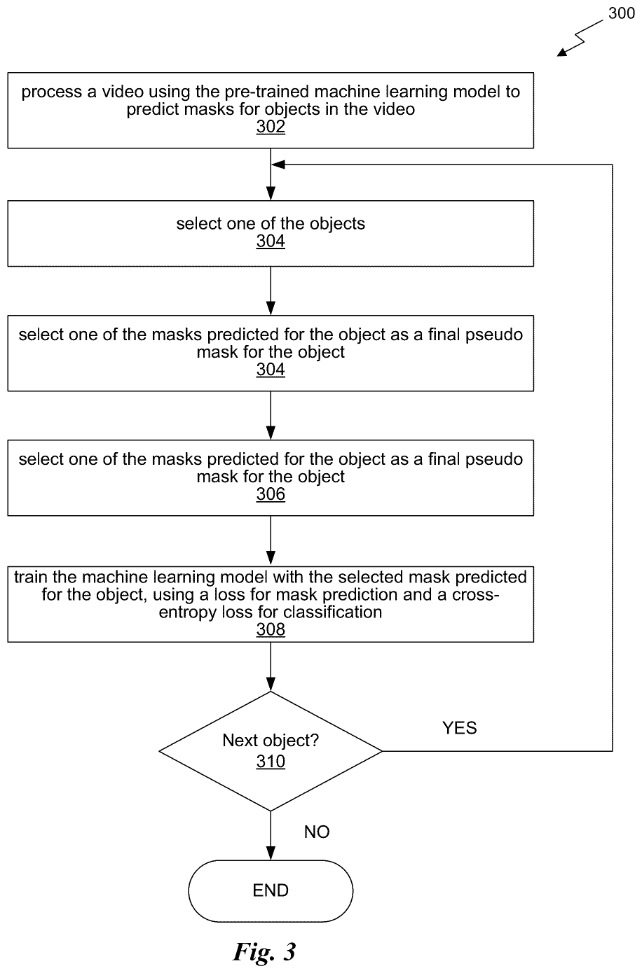

FIG. 3 illustrates a flowchart of a method 300 for fine-tuning of the pre-trained machine learning model 200 of FIG. 2 to perform video instance segmentation, in accordance with an embodiment. Of course, the present embodiment is just one specific example of the process for fine-tuning of the pre-trained machine learning model 200 of FIG. 2.

In operation 302, a video is processed using the pre-trained machine learning model to predicts masks for objects in a video. The video has been annotated with point-level annotations for one or more objects in the video. One of the objects is selected in operation 304. Selection of the object may be made from objects having point-level annotations in the video.

In operation 306, one of the masks predicted for the object is selected as a final pseudo mask for the object. The mask selection may be made based on a defined criteria, such as by using the point-level annotation defined for the object as a negative cue for other objects in the video to filter out masks predicted for the other objects in the video and/or based on a matching cost computed for each of the masks predicted for the object.

In operation 308, the machine learning model is trained with the selected mask predicted for the object, using a for mask prediction and a cross-entropy loss for classification. The method 300 then determines in decision 310 whether there is a next object to be selected. If so, the method 300 returns to operation 304 to select a next object and to train the machine learning model accordingly per operations 306-308. Once it is determined in decision 310 that no further objects remain to be selected, the method 300 terminates.

While not shown, it should be noted that the method 300 may be repeated again beginning with operation 302 for the same video. This may allow for additional fine-tuning of the method 300. Of course, the method 300 may be repeated for the same video any number of times, such as until a defined stopping criteria is met.

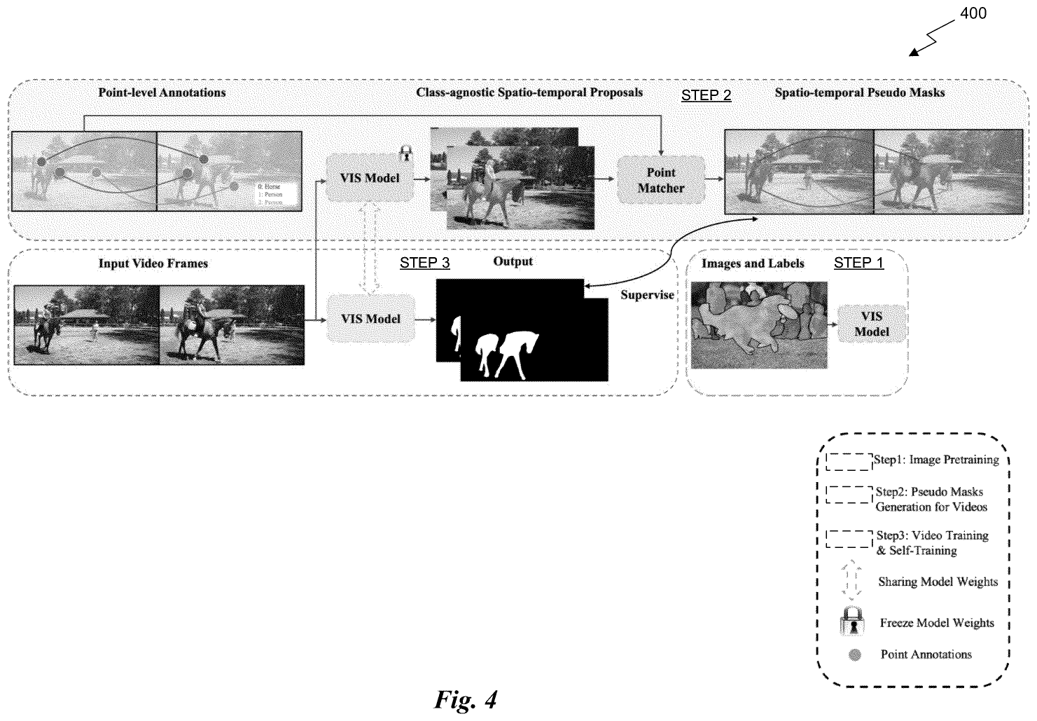

FIG. 4 illustrates a block diagram of a data flow 400 for providing point-level supervision for video instance segmentation, in accordance with an embodiment. The data flow 400 may be implemented in the context of any of the figures and descriptions given above. To this end, definitions given above may equally apply to the present embodiment.

As shown, in a first step, a machine learning model (denoted as a video instance segmentation model, or “VIS Model”) is pre-trained on an image data set to perform instance segmentation. In a second step, the pre-trained machine learning model is used to generate spatio-temporal mask proposals in training videos, and a point-based matcher is then employed which incorporates annotation-free negative cues from other instances in the same video frame. In a third step, generalization for new categories in videos is addressed by conducting self-training to mitigate the domain gap and refine the results. The training is iterated with pseudo masks from a prior round. These solutions together allow us to learn video instance segmentation with points effectively.

Embodiments of the three steps of the data flow 400 will now be provided.

### Step 1

Since image instance segmentation datasets with mask annotations are readily available, a model may be pretrained on such datasets to identify object shape. This pretrained model will equally identify rough object shape in videos, even through never trained on videos specifically and even where the objects categories between the images and the videos do not fully overlap.

### Step 2

Given the pretrained machine learning model, dense class-agnostic spatio-temporal proposals are generated for each video. Concretely, given an image model F(; θ_{I}) trained on D_{I} and a video sequence V from D_{Vp}, we obtain the initial proposals \hat{R} for V by directly conducting inference per Equation 1.

$$\hat{R} = F ( V ; {θ}_{1} ) = {\{ {\hat{M}}_{r} , {\hat{c}}_{r} \}}_{r = 1}^{R} \qquad Equation 1$$

Where \hat{M}∈ [symbol] ^{H×W×T} is a spatio-temporal proposal with continuous logits after sigmoid but before binarization, ĉᵣ is the confidence score, and R is the maximum number of proposals for a video (e.g. 100).

Since there could be new categories in Dv and F(; θ_{I}) has never been finetuned on Dv, the confidence score cᵣ is not meaningful for every video. To represent the confidence of class-agnostic proposals without the reliance on categories, a maskness score is used to obtain the confidence of an extracted mask as

$${c}_{r} = \frac{1}{HxWxT} {\sum }_{x , y , z} {\hat{M}}_{r} ( x , y , z )$$

where x,y are the x-axis and y-axis spatial coordinates, and where t indexes time.

Therefore, the final class-agnostic dense spatio-temporal proposals R for a video V is denoted as R={Mᵣ, cᵣ}ᵣ₌₁^{R}, where Mᵣ∈ [symbol] ^{H×W×T} is the binarized mask of \hat{M}ᵣ, and ĉᵣ is the maskness score.

Given the dense class-agnostic proposals, the best proposal should be assigned to a video object and the final pseudo mask produced, based on the point annotations given in the video. There could be multiple proposals that are overlapping with a single point annotation, which makes is necessary to identify which mask proposal provides the best boundary information.

To effectively match between proposals and video objects with points, a point-based matcher is used which can combat a severe lack of negative points during matching, especially when only positive points are annotated. In particular, cross instance negative cues may be used to largely filter out inaccurate proposals, as positive points for one video object are actually accurate negative points for the other video objects in the same video frame. Therefore, the pseudo label filtering problem is formulated as a bipartite matching problem between the proposals and the video objects with point annotations, and the matching cost is designed to incorporate an annotated cue, a cross instance negative cue and a maskness cue detailed as below.

Specifically, a search is performed for a permutation \hat{σ} between the set of dense proposals and the set of video ground truths with points given a video. Assuming R is larger than the number of objects in the video, G is considered as a set of video ground truth with size R padded with Ø (no object). To find a bipartite matching between R and G, a search is performed for a permutation σ∈Ω_{R} of R elements with the lowest cost, per Equation 2.

$$\hat{σ} = \begin{matrix}arg min \\ σ ∈ {Ω}_{R}\end{matrix} {\sum }_{j = 1}^{R} {ℒ}_{match} ( {G}_{j} , {R}_{σ ( j )} ) \qquad Equation 2$$

where [symbol] _{match} (Gⱼ, R_{σ(j)}) is a pair-wise matching cost between ground truth Gⱼ and a proposal with index σ(j). This optimal assignment is computed efficiently with the Hungarian algorithm. For matching cost [symbol] _{match} given point annotations, multiple sub-costs are computed as described below.

An annotated cost [symbol] ₐₙₙ(Gⱼ, R_{σ(j)}) is defined to penalize proposals who do not overlap with the annotated points Pⱼ^{t} for the i^{th} frame over T frames per Equation 3:

$${ℒ}_{ann} ( {G}_{j} , {R}_{σ ( j )} ) = - {\sum }_{t = 1}^{T} {\sum }_{k = 1}^{{N}_{t}^{j}} [ {M}_{σ ( j )} ( {P}_{j}^{t} ( k ) m , t ) \neq {L}_{j}^{t} ( k ) ] \qquad Equation 3$$

where [symbol] [⋅] is the indicator function, k is the point index, t is the time index, Pⱼ^{t}(k)∈ [symbol] ² is the x-y coordinates for the k^{th} point of the j^{th} video object at the t^{th} frame.

A cross instance negative cost [symbol] _{cineg}(Gⱼ, R_{σ(j)}) is defined to accumulate negative cues. Additional accurate negative point annotations are obtained for each video object by aggregating the positive point annotations from other video instances in the same video frame. Therefore, [symbol] _{cineg} is used to penalize proposals who overlap with the positive ground truth annotated points in other video instances.

A maskness cost [symbol] ₘₐₛₖₙₑₛₛ is defined as the negative of the maskness score to favor more confident proposals.

Therefore, the matching cost [symbol] _{match} is a weighted combination of the annotated cost, cross instance negative cost and maskness cost as per Equation 4.

$${ℒ}_{match} = {λ}_{1} {ℒ}_{ann} + {λ}_{2} {ℒ}_{cineg} + {λ}_{3} {ℒ}_{maskness} \qquad Equation 4$$

where λ₁, λ₂, λ₃ are the weight balancing parameters. With this designed matching cost, a high quality dense pseudo mask can be obtained for each video object with point annotations via the optimal permutation.

### Step 3

With the above high-quality pseudo masks, the video instance segmentation model is trained on videos with standard loss for mask prediction (cross-entropy and dice loss) and cross-entropy loss for classification.

To generalize from images to videos for new categories, self-training is conducted by regenerating pseudo labels again from the fine-tuned video model. The reason is that the pseudo labels are initially generated from an image model that has never been trained on videos, and there is an obvious domain gap. During self-training, a confidence score is used instead of a maskness score for pseudo label matching as the model has been finetuned on videos.

To this end, the data flow 400 described above, allows for a reduction in the required annotations to only one point for each object in a video frame, while retaining high quality mask prediction.

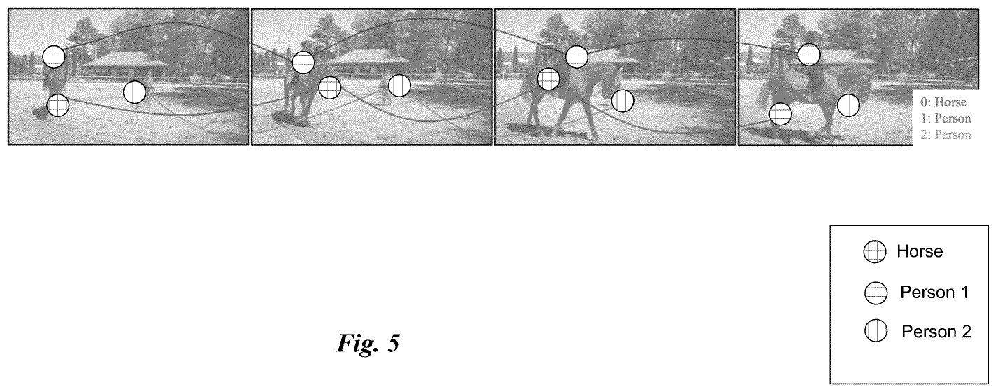

FIG. 5 illustrates an example of pseudo masks predicted for objects in a video, in accordance with an embodiment. Each of the pseudo masks refers to a mask predicted for an object in the video, where specifically the mask has been predicted by the video instance segmentation machine learning model trained with point-level supervision in accordance with the method 100 of FIG. 1 (or any of the fine-tuned machine learning models further disclosed in FIGS. 2-4). As mentioned in the embodiments above, the pseudo mask for an object may be selected from a plurality of masks predicted for the object, based on some defined criteria.

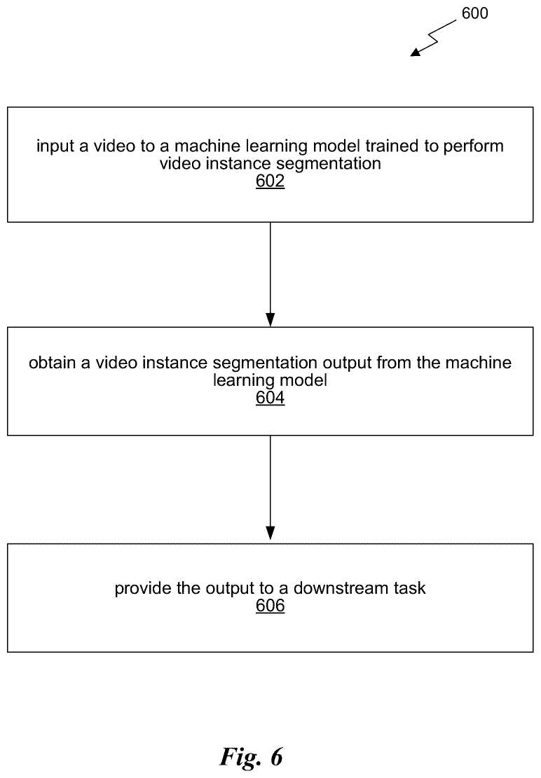

FIG. 6 illustrates a flowchart of a method 600 for video instance segmentation, in accordance with an embodiment. The method 600 may be performed using the video instance segmentation machine learning model trained in the method 100 of FIG. 1. In other embodiments, the method 600 may be performed using any of the fine-tuned machine learning models further disclosed in FIGS. 2-4).

In operation 602, a video is input to a machine learning model that has been trained to perform video instance segmentation. In operation 604, a video instance segmentation output is obtained from the machine learning model. The video instance segmentation output may refer to a mask for one or more objects in the video, which defines a location of the object (e.g. per frame of the video), a classification of the object, a boundary (e.g. bounding box) of the object within the frames of the video, etc. In operation 606, the output is provided to a downstream task. The downstream task refers to any function, process, application, etc. that is configured to take the video instance segmentation output as an input for performing some operation thereon. For example, the downstream task may be an video editing task, a 3D reconstruction task, a 3D navigation task (e.g. for autonomous driving and/or robotics), and/or a view point estimation task.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

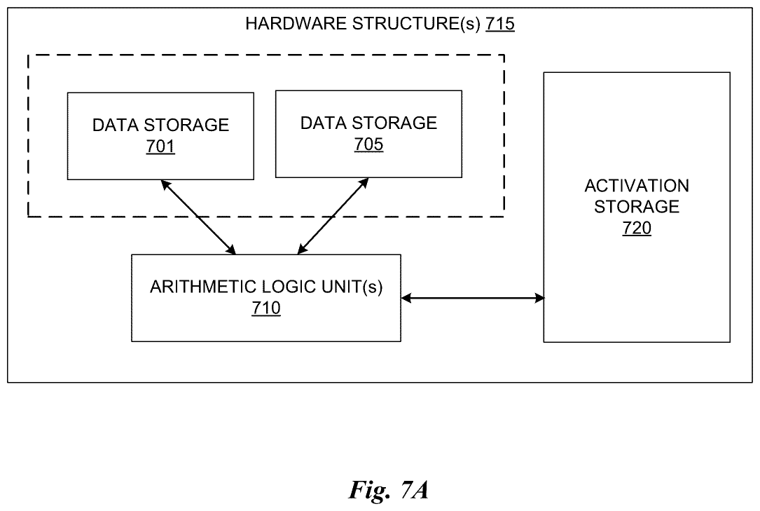

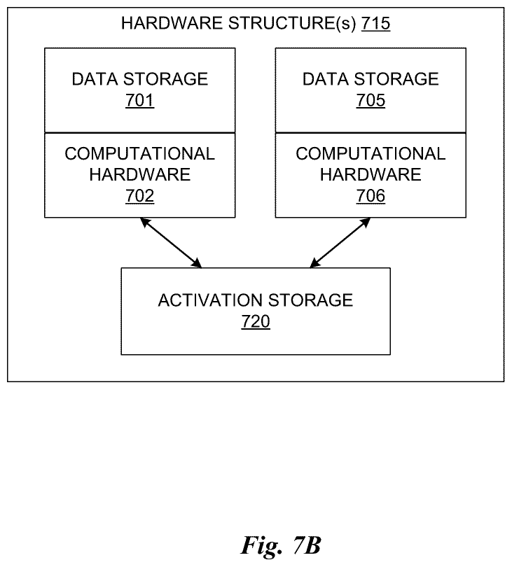

As noted above, a deep learning or neural learning system needs to be trained to generate inferences from input data. Details regarding inference and/or training logic 715 for a deep learning or neural learning system are provided below in conjunction with FIGS. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

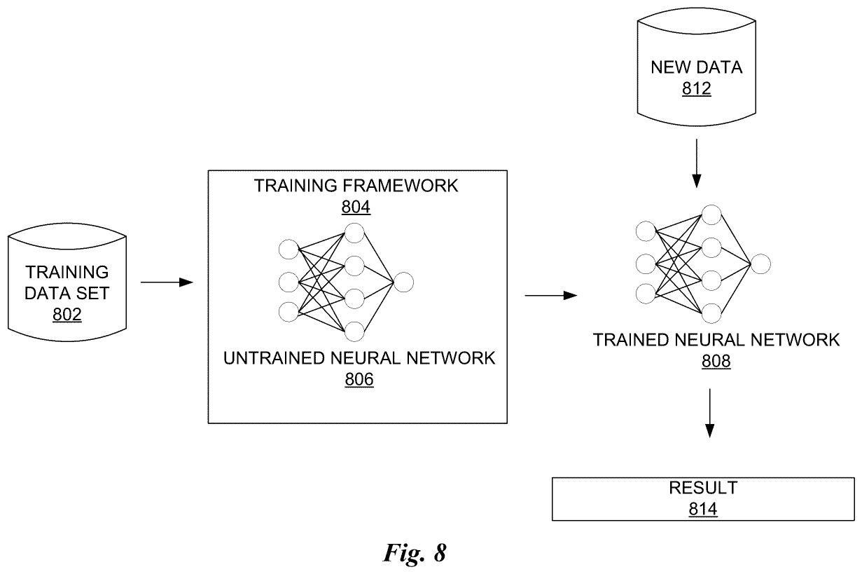

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

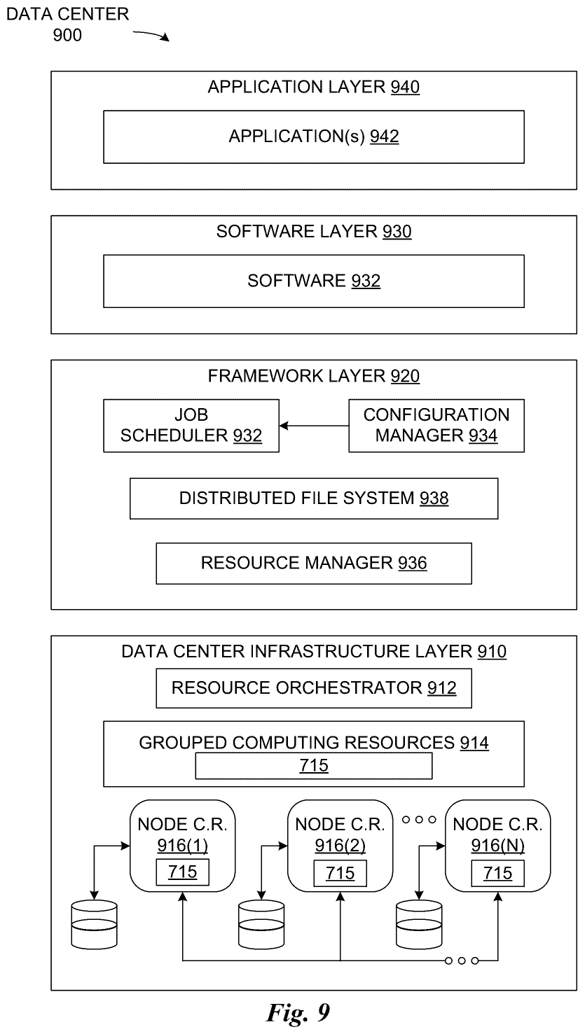

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920, one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920, one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed for point-level supervision for video instance segmentation models. In accordance with FIGS. 1-6, embodiments may provide machine learning models usable for performing inferencing operations and for providing inferenced data and in particular for performing video instance segmentation. The machine learning models may be stored (partially or wholly) in one or both of data storage 701 and 705 in inference and/or training logic 715 as depicted in FIGS. 7A and 7B. Training and deployment of the machine learning models may be performed as depicted in FIG. 8 and described herein. Distribution of the machine learning models may be performed using one or more servers in a data center 900 as depicted in FIG. 9 and described herein.

What is claimed is:

1. A method, comprising:
at a device:
determining a point-level annotation defined for at least one object in a video; and
using the point-level annotation for the at least one object to train a machine learning model with point-level supervision to perform video instance segmentation.

2. The method of claim 1, wherein the point-level annotation is defined for a point on an object and indicates a classification of the object.

3. The method of claim 2, wherein the point-level annotation further indicates coordinates of the object in a frame of the video for which the point-level annotation is defined.

4. The method of claim 2, wherein the point-level annotation further indicates whether the object is in a foreground or background of the video.

5. The method of claim 1, wherein the point-level annotation is input by a user.

6. The method of claim 1, wherein the point-level annotation is defined for the at least one object over a plurality of frames of the video.

7. The method of claim 6, wherein the plurality of frames are a sampled subset of all frames in the video.

8. The method of claim 1, wherein the point-level annotation is defined for the at least one object in a single frame of the video.

9. The method of claim 1, wherein using the point-level annotation for the at least one object to train the machine learning model with point-level supervision to perform video instance segmentation includes:
densifying the point-level annotation for training the machine learning model to perform video instance segmentation.

10. The method of claim 1, wherein using the point-level annotation for the at least one object to train the machine learning model with point-level supervision to perform video instance segmentation includes:
using the point-level annotation for an object of the at least one object as a negative cue for other objects in the video.

11. The method of claim 1, wherein the machine learning model is pre-trained on a data set of images having mask annotations for objects in the images.

12. The method of claim 11, wherein training the machine learning model with point-level supervision includes:
processing the video by the pre-trained machine learning model to predict masks for one or more objects in the video, and
fine-tuning the pre-trained machine learning model based on the point-level annotation defined for the at least one object in the video and based on the masks predicted for the one or more objects in the video.

13. The method of claim 12, wherein the pre-trained machine learning model further outputs a confidence score for each of the masks predicted for the one or more objects in the video.

14. The method of claim 12, wherein at least one of the one or more objects in the video can be of a new category for which the machine learning model is not pre-trained.

15. The method of claim 12, wherein fine-tuning the pre-trained machine learning model based on the point-level annotation defined for the at least one object in the video and based on the masks predicted for the one or more objects in the video includes, for each object of the at least one object in the video for which the point-level annotation is defined:
selecting one of the masks predicted for the object as a final pseudo mask for the object, and
training the machine learning model with the selected mask predicted for the object, using a loss for mask prediction and a cross-entropy loss for classification.

16. The method of claim 15, wherein the loss for mask prediction includes a cross-entropy and dice loss.

17. The method of claim 15, wherein one of the masks predicted for the object is selected by using the point-level annotation defined for the object as a negative cue for other objects in the video to filter out masks predicted for the other objects in the video.

18. The method of claim 15, wherein one of the masks predicted for the object is selected based on a matching cost computed for each of the masks predicted for the object.

19. The method of claim 18, wherein the matching cost is computed for each of the masks predicted for the object based on an annotated cost which penalizes masks predicted for the object that do not overlap with the point-level annotation defined for the object.

20. The method of claim 18, wherein the matching cost is computed for each of the masks predicted for the object based on a cross-instance negative cost that penalizes masks predicted for the object that overlap with a point-level annotation defined for another object in the video.

21. The method of claim 18, wherein the matching cost is computed for each of the masks predicted for the object based on a confidence cost that is a negative of a confidence score of the masks predicted for the object.

22. The method of claim 18, wherein the matching cost is computed for each of the masks predicted for the object based on an aggregate of:
an annotated cost which penalizes masks predicted for the object that do not overlap with the point-level annotation defined for the object,
a cross-instance negative cost that penalizes masks predicted for the object that overlap with a point-level annotation defined for another object in the video, and
a confidence cost that is a negative of a confidence score of the masks predicted for the object.

23. The method of claim 12, wherein training the machine learning model with point-level supervision further includes using self-training of the fine-tuned machine learning model by:
processing the video using the fine-tuned machine learning model to predict new masks for one or more objects in the video, and
performing additional fine-tuning of the fine-tuned machine learning model based on the new masks predicted for the one or more objects in the video.

24. The method of claim 23, wherein confidence scores are output by the fine-tuned machine learning model for the new masks predicted for the one or more objects in the video, and wherein the additional fine-tuning is performed based on the confidence scores.

25. A system, comprising:
a non-transitory memory storage comprising instructions; and
one or more processors in communication with the memory, wherein the one or more processors execute the instructions to:
determine a point-level annotation defined for at least one object in a video; and
use the point-level annotation for the at least one object to train a machine learning model with point-level supervision to perform video instance segmentation.

26. The system of claim 25, wherein the point-level annotation is defined for a point on an object and indicates a classification of the object.

27. The system of claim 25, wherein the point-level annotation is defined for the at least one object over a plurality of frames of a video.

28. The system of claim 25, wherein the point-level annotation is defined for the at least one object in a single frame of a video.

29. The system of claim 25, wherein using the point-level annotation for the at least one object to train the machine learning model with point-level supervision to perform video instance segmentation includes:
densifying the point-level annotation for training the machine learning model to perform video instance segmentation.

30. The system of claim 25, wherein using the point-level annotation for the at least one object to train the machine learning model with point-level supervision to perform video instance segmentation includes:
using the point-level annotation for an object of the at least one object as a negative cue for other objects in the video.

31. The system of claim 25, wherein the machine learning model is pre-trained on a data set of images having mask annotations for objects in the images.

32. The system of claim 31, wherein training the machine learning model with point-level supervision includes:
processing the video by the pre-trained machine learning model to predict masks for one or more objects in the video, and
fine-tuning the pre-trained machine learning model based on the point-level annotation defined for the at least one object in the video and based on the masks predicted for the one or more objects in the video.

33. The system of claim 32, wherein fine-tuning the pre-trained machine learning model based on the point-level annotation defined for the at least one object in the video and based on the masks predicted for the one or more objects in the video includes, for each object of the at least one object in the video for which the point-level annotation is defined:
selecting one of the masks predicted for the object as a final pseudo mask for the object, and
training the machine learning model with the selected mask predicted for the object, using a loss for mask prediction and a cross-entropy loss for classification.

34. The system of claim 32, wherein training the machine learning model with point-level supervision further includes using self-training of the fine-tuned machine learning model by:
processing the video using the fine-tuned machine learning model to predict new masks for one or more objects in the video, and
performing additional fine-tuning of the fine-tuned machine learning model based on the new masks predicted for the one or more objects in the video.

35. A non-transitory computer-readable media storing computer instructions which when executed by one or more processors of a device cause the device to:
determine a point-level annotation defined for at least one object in a video; and
use the point-level annotation for the at least one object to train a machine learning model with point-level supervision to perform video instance segmentation.

36. The non-transitory computer-readable media of claim 35, wherein the machine learning model is pre-trained on a data set of images having mask annotations for objects in the images.

37. The non-transitory computer-readable media of claim 36, wherein training the machine learning model with point-level supervision includes:
processing the video by the pre-trained machine learning model to predict masks for one or more objects in the video, and
fine-tuning the pre-trained machine learning model based on the point-level annotation defined for the at least one object in the video and based on the masks predicted for the one or more objects in the video.

38. The non-transitory computer-readable media of claim 37, wherein fine-tuning the pre-trained machine learning model based on the point-level annotation defined for the at least one object in the video and based on the masks predicted for the one or more objects in the video includes, for each object of the at least one object in the video for which the point-level annotation is defined:
selecting one of the masks predicted for the object as a final pseudo mask for the object, and
training the machine learning model with the selected mask predicted for the object, using a loss for mask prediction and a cross-entropy loss for classification.
